(19) United States
(12) Patent Application Publication
(10) Pub. No.: US 2010/0272261 A1
(43) Pub. Date: Oct. 28, 2010

(54) Data Security Transmission Wirelessly with Zigbee Chips

(75) Inventors: Chih-Yuan Su, Bangiao City (TW); Chun-Chin Chen, Taoyuan City (TW); Chun-Yi Chai, Hsinchu City (TW); Huan-Ping Su, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNIBAND ELECTRONIC CORP., Hsinchu (TW)

(21) Appl. No.: 12/430,276

(22) Filed: Apr. 27, 2009

(51) Int. Cl. H04L 9/00

(52) U.S. Cl. 380/270

(57) ABSTRACT

A wireless network system for data transmitting securely is disclosed. The system comprises a central control end for generating a cipher password per predetermined time unit. The central control end has a first Zigbee chip, a computer terminal for a user to input parameters, and a cryptographic algorithm program provided wherein the cryptographic algorithm program and the parameters are provided for password encryption using the cryptographic algorithm program is run by a microprocessor of the first Zigbee chip. The system also comprises a data transmitting end and a several data receiving ends. The data transmitting end using the Zigbee decrypts the cipher password and encrypts the data file using the plain password and the Zigbee chip. The data receiving ends using the Zigbee decrypt the cipher password and decrypt the cipher data file into plain data file by the WiFi chips using plain password.

### BACKGROUND OF THE INVENTION

1. Field of the Invention

The invention pertains to a data transmission over wireless system, and particularly to a wireless transmission system with data encryption/decryption transmission by WiFi chips and password encryption/decryption transmission by ZigBee chips.

2. Description of the Prior Art

Recently, personal computers (PC) seem like the most popular electrical appliance. The basic build-in equipment for those sold PCs is found to have a function of network connection nowadays from the multimedia equipment at past. The notebook PCs are further provided with wireless network connection function. The user can search information or interchange information with others, buy or sold goods, send or receive e-mails through the internet or intranet by PC. The user can also invest negotiable security, or MSN with friends so that the two or more ends of the network are like neighborhood of upstairs and downstairs. Besides, small and large enterprise provide with several servers for collogues interchange information and/or access data through either local network or internet network.

Internet can do a variety of functions for users and are almost boundless. It not only provides users with static information, information search but also further provides with video and audio files exchange interface such as web blogs at nowadays. User can access internet resource and share it with others and the thing he (or her) has to do is just connect the computer to the internet through ADSL or cable modem provided by ISP (internet service provider). Generally, any two remote computers having network adapters can access data each other in terms of the local network or internet. Moreover, more and more user and enterprises are using the wireless network or considering change thereto so as to lessen restrain from network cable.

Wireless network can deliver varieties of information including video, audio files, video-audio mixer files, documents, or application files no matter what formats the files are. However, in comparison with the physical connection such as network cable, the insecurity of the wireless network often act as the main against reasons for the opposition faction. Particularly, comparing to wire network, the immaterial transmission data over wireless network may be easier to be intercepted by the thinking people on the way of delivering but do not know by the sender and assigned receiver.

In spite of data communication over wireless in accordance with conventional technique, the security among the wireless router and the wireless adapters can be approaching through the key-in password or said web private key to prevent hiker's attack. However, most of the web private keys are fixed within a period of time. The time period may be one week or month or longer. In results, the wireless router is still easier to become an object for the hikers. Alternatively, some of types of routers provide easier ways of enforce changing the passwords thereof just by touching a button of the hardware, but that would restrict those users who can approach the routers. Hence it is still inconvenient. Apart from aforementioned disadvantage for the conventional routers, the passwords on the way of delivering are often insecurity. In addition, the data desired to be delivered by the transmitter to receivers are plain text or say not encrypted so that the data are easier to be intercepted.

The present invention uses Zigbee /802.15.4 protocol to encrypt/decrypt the network password. The Zigbee chip is known to easy combine with a microprocessor so that the data encryption/decryption is easier to be conducted. The channel bandwidth for communication for Zigbee chip is a range between 2.4-2.5 Ghz. Apart from that the data file encryption/decryption to be transferred is by WiFi chip combine with the password encryption/decryption by Zigbee. It is thus very difficult for a hiker to acquire the plain data file even he intercepted the packets during transmitting.

### SUMMARY OF THE INVENTION

An object of the present invention is to overcome the disadvantages of prior art. and provided a wireless data security transmission system.

The present invention discloses a wireless network system for data transmitting securely. The system comprises a central control end for generating a cipher password per predetermined time unit. The central control end has a first Zigbee chip, a computer terminal for a user to input parameters, and a cryptographic algorithm program is run by a microprocessor of the first Zigbee chip using the forgoing parameters to generate a cipher password per predetermined time unit.

The system also comprises a data transmitting end having a second Zigbee chip, and a first WiFi chip to transmit a cipher data file and a sever of data receiving ends. Each of data receiving end has a Zigbee chip, and a WiFi chip to receive the cipher data file and decrypt them into plain data file.

In process, while a cipher password is received by the data transmitting end and the data receiving end simultaneously, a cipher password decryption into plain password is operated at the data transmitting end and the data receiving ends using the Zigbee chip there belong to. The, cipher data file is encrypted by using the plain password at the transmitting end, and the plain text file is obtained at the data receiving ends by using the plain password prior obtained to decrypt the cipher data file.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a wireless transmission system in accordance with the present invention.

FIG. 2 shows function blocks of a Zigbee chip.

### DESCRIPTION OF THE PREFERRED EMBODIMENT

The present invention is to disclose a method and a system to transmit data securely from one transmitting end to the receiving ends over wireless communication. The password for video or audio data encryption is encrypted firstly and sent by using a Zigbee chip thereafter and is changed per predetermined time unit. The cipher password is then decrypted at receiving ends and the transmitting end. The data to be delivered at the transmitting end is then encrypted by the plain password and run a cryptographic algorithm program at the transmitting end. After the packets received by the receiving end, the cipher data is then decrypted to plaintext by plain password.

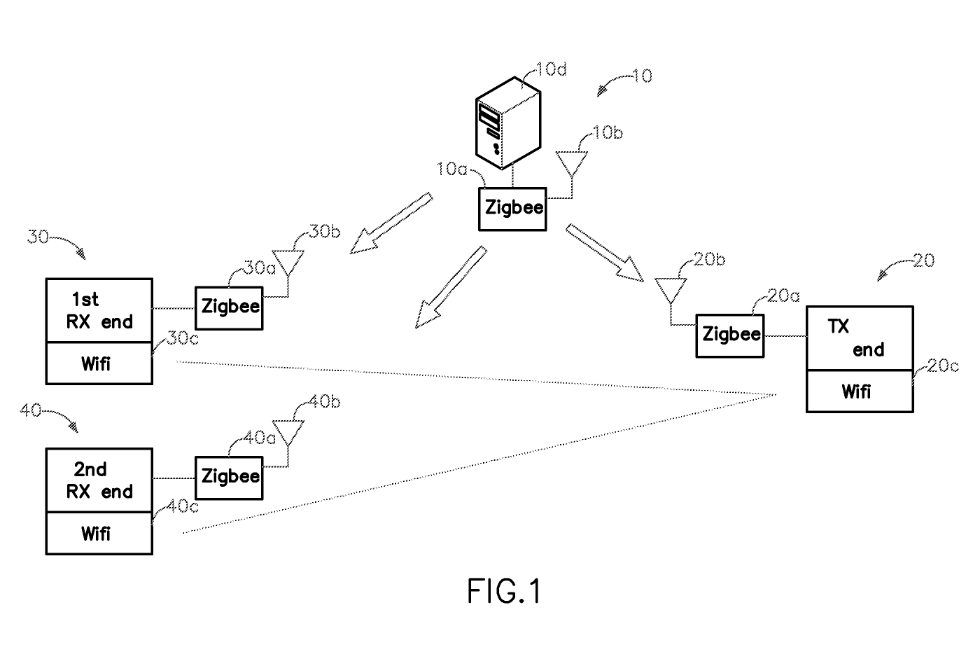

The schematic diagram of the system architecture according to the present invention is shown in FIG. 1. It includes a central control end.10, a data transmitting end 20 and several data receiving ends 30, 40 such as a first data receiving end 30, and a second data receiving end 40. The central control end 10 includes a computer or a terminal 10d, a Zigbee chip 10a, and an antenna 10b. The data transmitting end 20 includes a Zigbee chip 20a, an antenna 20b, and a WiFi chip 20c. The first data receiving end 30 and the second data receiving end 40 have the same apparatus as the data transmitting ends including a first Zigbee chip 30a, an antenna 30b, a WiFi chip 30c and a second Zigbee chip 40a, an antenna 40b, a WiFi chip 40c.

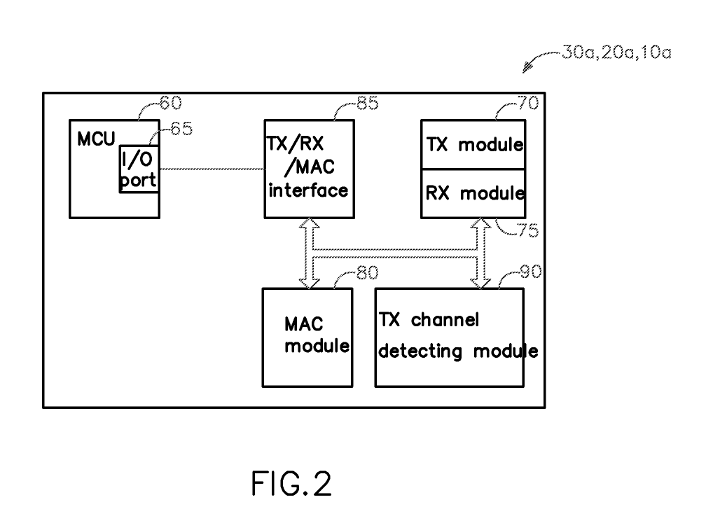

Every Zigbee chip 10a, 20a, 30a, and 40a has the same function modules shown in FIG. 2. The Zigbee chip 10a, 20a, 30a, and 40a has a receiving (RX) module 70, a transmitting (TX) module 75, a MAC (media access control modules 80, a control interface of transmitting/receiving/MAC 85, a transmitting channel detecting module 90, and a microprocessor (MCU) 95. The control interface of transmitting/receiving/MAC 85 includes an interface for input/output ports of MCU 60 connection.

The birthday, date, time or numerical related data, or mixed of them may be served as parameters of a cryptographic algorithm program for generating a network password at the central control end 10 and the parameters are inputted by a user through a computer 10d or a computer terminal. The password will be automatic updated to another per predetermined time unit. Preferably, the predetermined time unit is between about 30 min to 120 min. The cipher password is then encrypted using algorithm of 128 bytes advanced encrypted standard by MCU 60 executed the cryptographic algorithm program of the Zigbee chip 10a. The packet containing the network cipher password is delivered by a form of radio frequency signal and transmitted by a transmitting module 75 wirelessly to the data transmitting end 20 and first data receiving end 30 and a second data receiving end 40.

At the data transmitting end 20, the antenna 20b receives the RF signals, which are then received by receiving module 70, where the RF signals are then demodulated into the packet at the MAC module 80. Thereafter, the packet contains cipher password decryption i128 bits AES is implemented by the MAC module 80 of Zigbee chip 20a into a plain password. The plain password is then delivered to the WiFi chip 20c. The data to be transmitted are then encrypted with 64 bits using the plain password by the WiFi chip 20c. The data can be any files types such as video files, audio files, video-audio mixed files, text files, or picture's files.

At the first data received end 30, the antenna 30b receives the RF signals. The signals are then demodulated into packet by receiving module 70 or at the MAC module 80. Thereafter, the packet contains cipher password decryption of 128 bits AES is decrypted by the MAC module 80 of Zigbee chip 20a into the plain password. On the other hand, the cipher data packet received by WiFi chip 30c will be decrypted into plain data file.

Similarly, at the second data receiving end 40, similar procedures as the first data receiving end 30 in terms of the Zigbee chip 40b to obtain the plain password and then in corporate with the WiFi chip 40c to decrypt the cipher data into plain data.

Worthwhile to note, the password is renew to another per predetermined time unit and delivered to many receiving ends simultaneously.

The benefits of the present invention are:

The password delivered is done over a wireless network and changed within a very short of time in comparison with the prior art and the time can also be changed in according to the user's request.

The cipher password and cipher data are respectively, encrypted by Zigbee chip and WiFi chips and sent. And it is expected that the plaintext can be transmitted securely.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A wireless network system for data transmitting securely, comprising:
a central control end for generating a cipher password per predetermined time unit, having a first Zigbee chip, a computer terminal for a user to input parameters, and a cryptographic algorithm program, wherein said a cryptographic algorithm program and said parameters are provided for password encryption using said first Zigbee chip;
a data transmitting end having a second Zigbee chip, and a first WiFi chip to transmit a cipher data file;
a first data receiving end having a third Zigbee chip, and a second WiFi chip to receive said cipher data file and decrypt said cipher text file to a plain data file; and
wherein after said cipher password received by said data transmitting end and first data receiving end simultaneously, a cipher password decryption into plain password is operated at said data transmitting end using said second Zigbee chip and said first data receiving end using said third Zigbee chip and said cipher data file is encrypted by using said plain password at said transmitting end, and said plain text file is obtained at said first data receiving end by using said plain password to decrypt said cipher data file.

2. The wireless network system according to claim 1 wherein said parameters are numerical selected from the group consisting of birthday, time date, numbers and the combination thereof.

3. The wireless network system according to claim 1 wherein said predetermined time is between about 30 min to 120 min.

4. The wireless network system according to claim 1 wherein said cipher password is generated in terms of 128 bits of advanced encrypted standard

5. The wireless network system according to claim 1 wherein said cipher password is generated by running cryptographic algorithm program using said parameters and said a microprocessor of said first Zigbee chip.

6. The wireless network system according to claim 1 wherein said cipher data file is encrypted by using said first WIFI chip
